(19) United States
(12) Patent Application Publication
(10) Pub. No.: US 2014/0040414 A1
(43) Pub. Date: Feb. 6, 2014

(54) METHODS AND SYSTEMS FOR PROVIDING EVENT RELATED INFORMATION

(71) Applicant: Formula 3 Group, LLC, Huntington Beach, CA (US)

(72) Inventors: Phaedrus Ronchi, Huntington Beach, CA (US); Andrew Spear, Huntington Beach, CA (US)

(21) Appl. No.: 13/917,995

(22) Filed: Jun. 14, 2013

Related U.S. Application Data
(60) Provisional application No. 61/659,711, filed on Jun. 14, 2012.

(51) Int. Cl. H04L 29/06

(52) U.S. Cl. CPC H04L 65/60
USPC 709/213; 709/219

(57) ABSTRACT

Systems and methods are disclosed for providing a platform where a user is able to obtain live information about an event such as live recordings, video recordings, photos, comments and the like, from a location of the event. A user may connect to the platform via the Internet and have access to content regarding the event and generated either by a platform manager or by other users. The user may also obtain recorded information, such as footage of the event, after the event has taken place, by accessing the platform and searching footage via search criteria or keywords.

The current application claims priority from provisional U.S. Patent Application No. 61/659,711 entitled “Methods and Systems for Providing Event Related Information,” filed on Jun. 14, 2012, which is incorporated herein by reference in its entirety.

### BACKGROUND OF THE INVENTION

1. Field of Invention

Aspects of the present invention relate to methods and systems for providing event information to one or more users. More particularly, aspects of the current invention relate to methods and systems for providing live event and user-generated information about an event to one or more users.

2. Description of Related Art

Currently, live events that are not broadcast through conventional channels such as television (TV), radio or the Internet, are not easily accessible to people who are not physically present at the live event. For example, people who cannot be present at a given event currently have no option to obtain information on the event other than relying on secondary information such as word of mouth or random recordings obtained from third parties who were present the event.

Accordingly, it is difficult for a person who was not present at an event to obtain accurate information about the event, footage, scores or other information, either live or recorded, when the event is not broadcast through a conventional media channel such as TV, radio or the Internet.

### SUMMARY OF THE INVENTION

In light of the above described problems and unmet needs, aspects of the current invention provide systems and methods for providing a platform that enables a user to obtain live information about an event such as, for example, live recordings, video recordings, photos, comments and the like, from a remote location. According to various aspects, a user may connect the platform via the Internet and may obtain access to content regarding the event, the content being generated either by a platform manager or by other users. According to various aspects, a user may also obtain recorded information such as footage of the event, after the event has taken place, by accessing the platform and searching for the footage or other information using search criteria or keywords, among other information. Accordingly, the user may, for example, visualize specific portions of an event on the basis of the searching criteria. For example, for a sporting event, the user may search any footage available for a specific player, a player of a specific nationality, a team, a score, and the like.

Additional advantages and novel features of these aspects of the invention will be set forth in part in the description that follows, and in part will become more apparent to those skilled in the art upon examination of the following or upon learning by practice of the invention.

### BRIEF DESCRIPTION OF THE DRAWINGS

Various example aspects of the systems and methods of aspects of the present invention will be described in detail, with reference to the following figures, wherein:

FIG. 1 is a diagram illustrating a system of coverage of an event, according to various aspects of the current invention;

FIG. 2 is a diagram illustrating the architecture of a system according to various aspects of the current invention;

FIG. 3 is a flowchart illustrating a method of covering an event, according to various aspects of the current invention;

FIG. 4 presents an example system diagram of various hardware components and other features, for use in accordance with an aspect of the present invention; and

FIG. 5 is a block diagram of various example system components, in accordance with an aspect of the present invention.

### DETAILED DESCRIPTION

These and other features and advantages of this invention are described in, or are apparent from, the following detailed description of various example aspects.

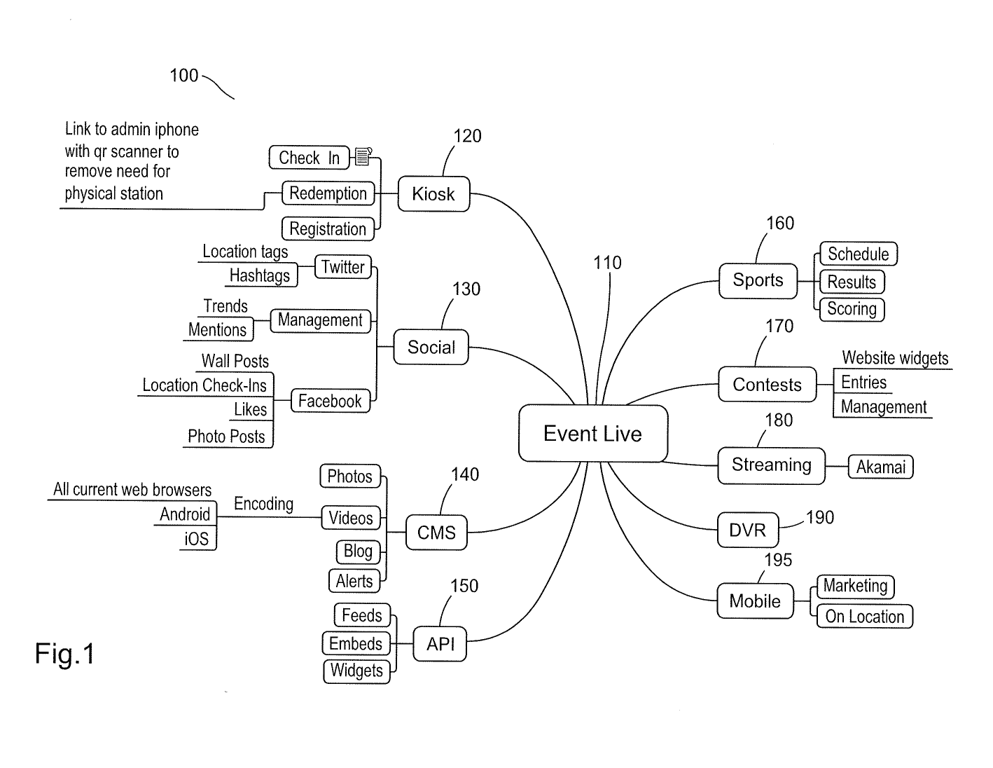

FIG. 1 is a diagram illustrating a system of coverage of an event, according to various aspects of the current invention. The system 100 may include a platform 110 enabling, for example, a user to access information relative to an event. According to various aspects of the current invention, the platform may be connectable to the Internet and may include input and output devices as well as display and communication devices. According to various aspects, the user may access the platform during the occurrence of the event such as, for example, a live sporting event via, for example, the Internet. According to various aspects, one or more kiosks 120, which are items that encourage social engagement, may be provided at one or more locations of the live event, wherein users or third parties may access the platform from one of the kiosks 120 and, for example, post or provide information relative to the live event. According to various aspects, if the venue of the event is a particularly large venue such as, e.g., a mile long beach in the case of the U.S. Open of Surfing, then the kiosks 120 may be located at regular intervals along the beach or at various other locations to be in proximity to most or all of the spectators and of the participants in the event. The information posted at the kiosks 120 by the users, platform managers or third parties may include audio/video recordings, scoring updates, comments, and the like.

According to various aspects, during an event, information about the event may be posted at a kiosk 120 and then routed from the kiosk 120 to the platform 110, where the posted information may be rendered accessible to a remote user. At the kiosk 120, the user, platform manager or third party providing information about the event may first log in and register in order to be allowed to post information about the event. Alternatively, the user, platform manager or third party may not need to login in order to post information at the kiosk 120. A third party may be, for example, an entity that organizes the event, or that collaborates with organizers of the event. For example, a third party may provide information, which may be designated as official information, such as scoring, player names, information relative to participants or players, and the like.

According to various aspects, although actual kiosks 120 may be physically located at various portions of the venue of the event, the kiosks 120 may also be mobile devices, such as mobile telephones, smart devices, tablets, digital cameras, digital video recorders, etc., carried by spectators, users, platform managers, players or third parties. For example, the owner or holder of a mobile device may log in the system and use the mobile device as a kiosk 120 as discussed above. It should be noted that a user can also redeem points or rewards accumulated by posting the information at the kiosk 120. For example, a user that posts a large amount of information may accumulate points redeemable to receive various prizes, clothing items and/or cash.

According to various aspects, users can also post information about the event on a social website 130, and the information may be transmitted to the platform 110 in order to be rendered accessible to other users. Accordingly, besides being accessible via the platform 110, the event, as well as the venue where the event takes place, may be displayed on a user's social website, either live or via previously recorded videos or other information display, and the event may thus become accessible to other parties who may be potential users and who may be connected to the user's social website. In addition, the information made accessible via the kiosk 120 may be transmitted to the social website 130 of one or more users that are authorized to access the platform 110. Accordingly, information about the event may be streamed directly to a user's social website account 130. Alternatively, information posted by a user at the user's social website account 130 may be transmitted to the platform 110 and made accessible to other users.

According to various aspects, the platform 110 may be coupled to a content management system (CMS) 140, where the content posted on the platform 110 by users or third parties may be received, stored and managed via the CMS 140. For example, the CMS 140 may organize the information received in the form of a plurality of searchable categories, and may provide a search engine to enable the selection of content such as, for example, photos, videos, comments, postings, scores, participants' names, participants' nationalities, and the like, on the basis of various searched categories. The results of the search, provided to the user, may be displayed on the user's computer, smart device or social website. According to various aspects, the CMS 140 may communicate with the platform 110 via an Application Programming Interface (API) 150, which may be an interface enabling authorized third parties that may provide official information about the event or sponsorship for the event, such as event organizers or sponsors, to communicate with the platform 110 and the CMS 140. In the case of a sponsor, the sponsor may communicate with the platform 110 via the API 140 to post official scoring or other information on the sponsor's website, for example. According to various aspects, users who cannot log in the platform 110 may or may not have the ability to communicate with the platform 110 via the API 140.

According to various aspects, the event being covered via the platform 110 may be a sporting event 160, but may also be any other event that takes place live (e.g., in real time) and that may interest spectators, such as a concert, a political event or a news event. In the case of a news event, for example, witnesses to a news events such as, for example, a tornado, may post information or videos at a kiosk such as the kiosks 120 discussed above, and the information may be transmitted to the platform 110 for dissemination to other users. Users accessing the platform 110 remotely via a kiosk 120 may also have the ability to enter one or more contests 170 to earn, e.g., prizes, points, or other awards.

According to various aspects, the event may also be accessed live via streaming 180 from the platform 110, where a user may log in the platform 110 and watch the event live on the user's computer or smart device. According to various aspects, the user may view a plurality of event locations or shooting angles from the user's computer or smart device. According to various aspects, streaming 180 of the live event may be provided by one or more third parties, such as event organizers or sponsors, who may provide official information about the event such as live footage of the event, scoring of the event, participants in the event, and the like. The information provided by the third parties may be accessible to the users via the platform 110.

According to various aspects, post-event digital video recording (DVR) or on-demand capability 190 may also be provided to users of the system 100. For example, after the event has concluded, one or more users may have the ability to access the platform 110 and search through the various recordings, photos, or other information relative to the event in order to select specific information, recordings, portions of the event via a plurality of shooting angles, information or footage of specific players, and the like, via the platform 110. For example, in order for a search to be performed by a user, a third party, such as a platform manager, an event organizer, a sponsor, or an official provider of footage and other information about the event, may edit the information in searchable form after the event has taken place, encode the information in digital form, and provide the searchable information to users via the platform 110. Accordingly, a user may access the platform 110 to use the DVR or on-demand capability 190, according to aspects of the current invention, and search for specific portions of the event that are of interest to the user. For example, a user may elect to view only portions of the event that involve a specific player or participant, portions of the event that took place during specific periods of time, participants or players from a specific country, participants or players who scored above a certain level, or the like.

In an event such as, for example, the U.S. Open of Surfing, the user may elect to view the performance of a specific participant, or of a specific group of participants such as participants of a certain nationality, or participants who performed a specific routine. According to various aspects, the user may achieve this goal via the DVR 190 by entering search words or keywords at the platform 110 via the user's smart device, computer or kiosk 120, the platform 110 communicating with the DVR 190 to perform the search. As such, the user may obtain a selection of footage, information, and the like, that is the result of the user's search. According to various aspects, the contents of the footage or information provided to the user may be provided via a third party such as an official provider of footage and other information about the event, and the information provided may be organized using one or more criteria made available to the user, which the user can select via the platform 110.

According to various aspects, although the user may access the platform 110 via a computer, the user may also access the platform 110 via a mobile device 195 such as a mobile telephone, a tablet, a smart device, or the like.

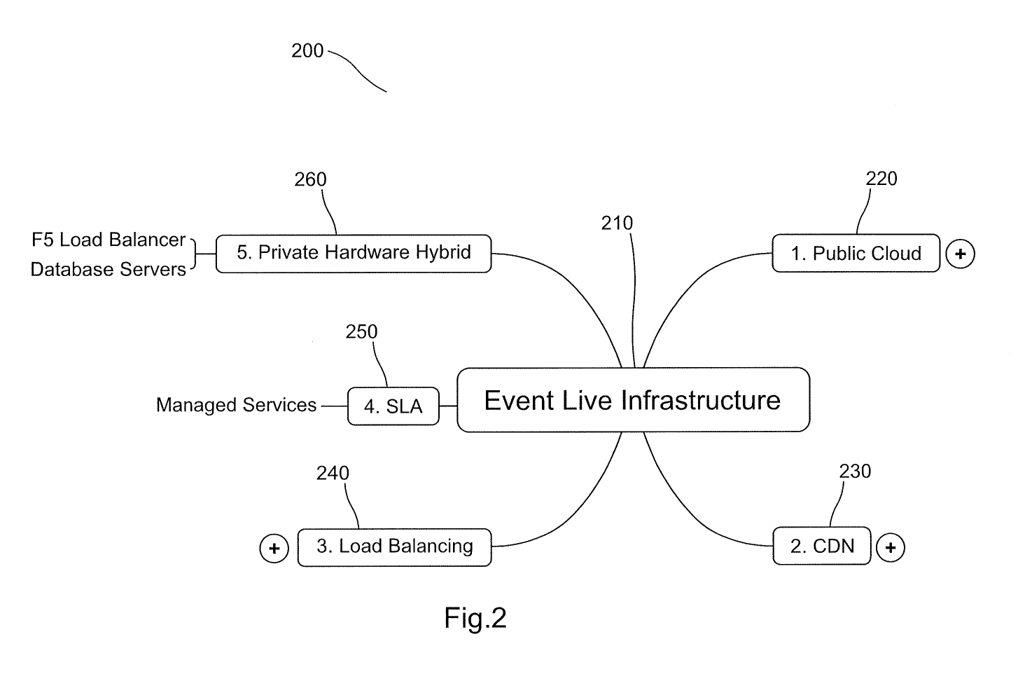

FIG. 2 is a diagram illustrating the architecture of a system 200 according to various aspects of the current invention. According to various aspects, the infrastructure of the system 200 may include the platform 210 having a content management system (CMS), which may be coupled to a storage area such as a public cloud 220, and to a Content Delivery Network (CDN) 230 that may provide storage and content management for content entered and received at the platform 210. According to various aspects, the public cloud 220 may be useful to distribute the amount of memory that may be needed for the period of time during which the event is taking place. For example, if the event takes place over a period of several days, or several weeks, then memory utilization may be at a peak during those several days or several weeks because a number of users may post or download videos, photographs or various posts during that period of time. However, during the remainder of the year, if the event is a yearly event, less computing and storage power may be needed because a smaller number of people may be logged in at any given time, and such varying computing and storage power needs can be accommodated via the public cloud 220. As such, the overall system is scalable and can be used to accommodate a large number of simultaneous users, such as during the occurrence of an event, or a smaller number of simultaneous users, such as after an event has taken place. For example, agreements between event organizers and users/third parties may be established in the form of Service Level Agreements (SLA) 250.

According to various aspects, the information made available to users may be distributed over the public cloud 220 via load balancing 240 and hybrid hardware 260 coupled with the public cloud 220. Load balancing 240, in accordance with aspects of the present invention, refers to a computer networking method for distributing workload across a plurality of computers or computer clusters, network links, central processing units, disk drives, or other like resources, to achieve optimal resource utilization, maximize throughput, minimize response time, and avoid overload. For example, using multiple components with load balancing, instead of a single component, may increase reliability through redundancy. The hybrid hardware 260, which is a hybrid cloud option, allows for some processes to be hosted and managed by the public cloud, while others to be kept on one or more private clouds. According to various aspects, the platform or CMS 210, the public cloud 220 and the CDN 230 may be connected to each other via a network such as, e.g., the Internet.

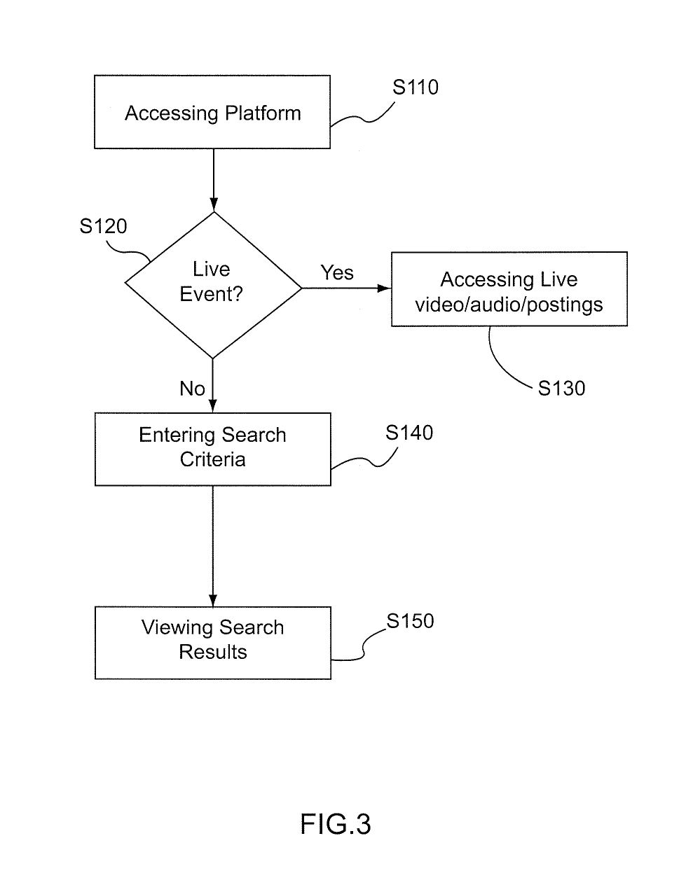

FIG. 3 is a flowchart illustrating a method of covering an event, according to various aspects of the current invention. According to various aspects, the method starts at S110, where a user may access the platform in order to observe an event live, or to obtain information about a live or previously recorded event. A determination may be made about whether the event being observed is a live event or a previously recorded event at S120. According to various aspects, if the event is a live event, then the user may access video, audio, live postings, and the like, relating to the event at S130. According to various aspects, at S130, the user may also post information at a kiosk by, for example, entering information, uploading videos at the kiosk, and the like. According to various aspects, at S130, the user may also post information via a remote device such as a smart telephone, a tablet, other portable electronic devices, and the like.

If the event is not a live event and has already taken place, then the user may enter search terms or search criteria in a search engine at S140. According to various aspects, when the search criteria are entered by the user, a search engine may search results corresponding to the search criteria and provide the results of the search to the user at S150. For example, the user may search any footage or information available, e.g., for a specific participant, or for participants of a specific nationality, and the information provided to the user may be footage, audio recording, postings and the like relative to the search. In order for a search to be performed by a user, a third party, such as an official provider of footage and other information about the event, may edit the information in searchable form after the event has taken place and prior to the searching capability being made available to the general public or to authorized users. According to various aspects, the official provider may encode the information in digital form, and provide the searchable information to users on demand via a platform.

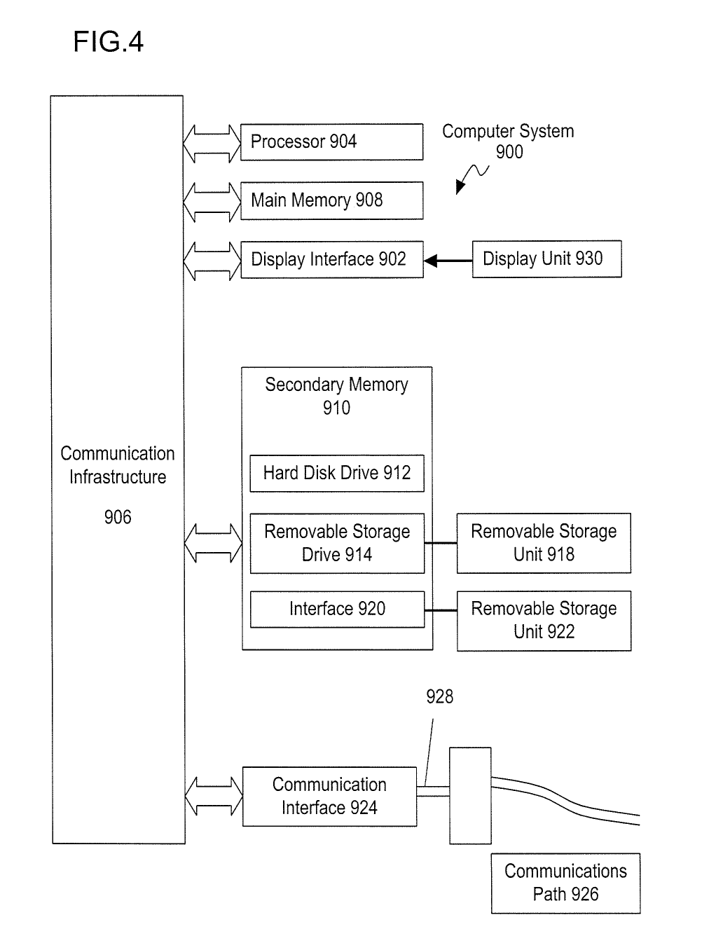

FIG. 4 presents an example system diagram of various hardware components and other features of the platform and kiosks, for use in accordance with an aspect of the present invention. The present invention may be implemented using hardware, software, or a combination thereof and may be implemented in one or more computer systems or other processing systems. In one aspect, the invention is directed toward one or more computer systems capable of carrying out the functionality described herein. An example of such a computer system 900 is shown in FIG. 4.

Computer system 900 includes one or more processors, such as processor 904. The processor 904 is connected to a communication infrastructure 906 (e.g., a communications bus, cross-over bar, or network). Various software aspects are described in terms of this example computer system. After reading this description, it will become apparent to a person skilled in the relevant art(s) how to implement the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data. In alternative aspects, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software to the computer system 900. The invention is directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 910 to perform the features of the present invention. Accordingly, such computer programs represent controllers of the computer system 900.

In an aspect where the invention is implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

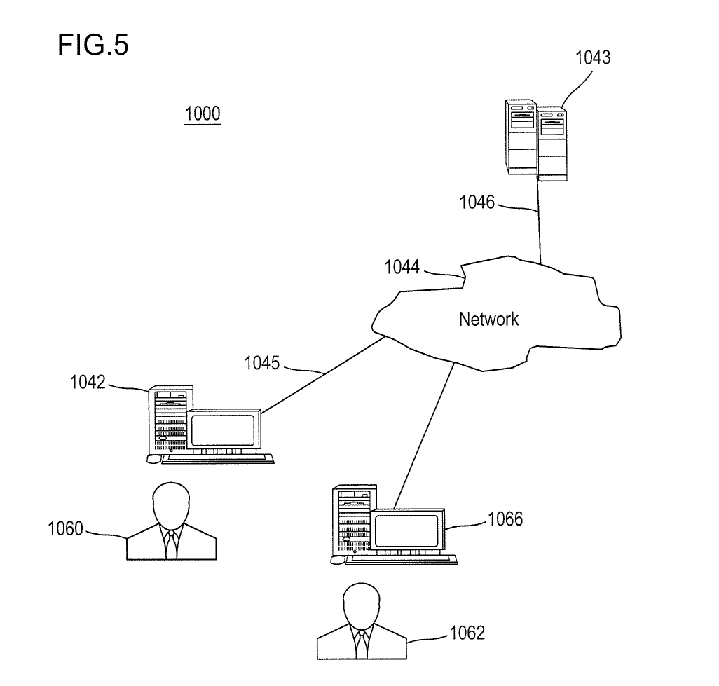

FIG. 5 is a block diagram of various example system components, in accordance with an aspect of the present invention. FIG. 5 shows a communication system 1000 usable in accordance with the present invention. The communication system 1000 includes one or more accessors 1060, 1062 (also referred to interchangeably herein as one or more “users”) and one or more terminals 1042, 1066. In one aspect, data for use in accordance with the present invention is, for example, input and/or accessed by accessors 1060, 1062 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, 1064 include, for example, wired, wireless, or fiberoptic links. In another aspect, the method and system of the present invention operate in a stand-alone environment, such as on a single terminal.

While aspects of this invention have been described in conjunction with the example features outlined above, various alternatives, modifications, variations, improvements, and/or substantial equivalents, whether known or that are or may be presently unforeseen, may become apparent to those having at least ordinary skill in the art. Accordingly, the example aspects of the invention, as set forth above, are intended to be illustrative, not limiting. Various changes may be made without departing from the spirit and thereof. Therefore, aspects of the invention are intended to embrace all known or later-developed alternatives, modifications, variations, improvements, and/or substantial equivalents.

What is claimed is:

1. A system for providing information about an event, the system comprising:
one or more kiosks located at one or more locations of, the event, wherein at least the kiosk is located remotely from the event; and
a platform coupled to the one or more kiosks and configured to manage information about the event;
wherein the one or more kiosks are configured to receive the information about the event and transmit the information about the event to the platform.

2. The system of claim 1, wherein the platform comprises a search engine and is configured to perform at least one of:
receive information about the event via the one or more kiosks;
render the information about the event accessible; and
render the information about the event searchable on the basis of a plurality of parameters;

3. The system of claim 2, wherein:
the platform is coupled to a network; and
the information about the event is remotely accessible to one or more users via the network.

4. The system of claim 3, wherein the network is the Internet.

5. The system of claim 1, wherein the kiosks are configured to perform at least one selected from a group consisting of receiving, storing, displaying and transmitting at least one selected from a group consisting of a video, a picture, data and an audio recording.

6. The system of claim 3, wherein the platform is configured to perform at least one of selected from a group consisting of receiving, storing, displaying and transmitting at least one selected from a group consisting of a video, a picture, data and an audio recording over the network.

7. The system of claim 6, wherein one or more portions of the at least one selected from a group consisting of the video, the picture, the data and the audio recording stored at the platform is searchable via the search engine.

8. The system of claim 7, wherein the search engine performs a search remotely over the network.

9. The system of claim 6, wherein the at least one of the group consisting of the video, the picture, the data and the audio recording is organized in searchable form at at least one of the group consisting of the platform and the kiosks.

10. The system of claim 1, wherein the one or more kiosks comprise one or more mobile devices.

11. The system of claim 10, wherein the one or more mobile devices comprise at least one of a group consisting of a smart telephone, a tablet, a smart device, a digital camera and a digital video recorder.

12. The system of claim 1, wherein the information about the event is at least one of a group consisting of live information and recorded information.

13. A method for providing information about an event comprising:
processing information about the event at one or more kiosks located at one or more locations of the event, wherein at least one kiosk is located remotely from the event;
transmitting the information about the event to a platform via the one or more kiosks; and
rendering the information about the event accessible;
wherein the information about the event is searchable based on a plurality of parameters via a search engine.

14. The method of claim 13, wherein at least one action selected from a group consisting of transmitting the information to the platform and rendering the information about the event accessible via the platform, is carried out over a network.

15. The method of claim 13, wherein processing the information comprises at least one action selected from a group consisting of receiving, storing, displaying and transmitting at least one of a video, a picture, data and an audio recording.

16. The method of claim 13, wherein rendering the information about the event accessible is performed at at least one location selected from a group consisting of the platform and the kiosks.

17. The method of claim 13, wherein rendering the information about the event accessible further comprises:
receiving an input related to a portion of the event from a user;
providing at least one selected from a group consisting of a video, a picture, data and an audio recording to the user in response to the input.

18. The method of claim 17, wherein the at least one selected from a group consisting of a video, a picture, data and an audio recording in response to the input is displayed on a device of the user.

19. The system of claim 1, wherein:
a memory of the platform is configured via load balancing; and
a load of the memory is distributed among a plurality of local or remote memory storage devices based on an amount of memory usage.

20. The method of claim 13, wherein:
the information about the event is stored at the platform;
a memory of the platform is configured via load balancing; and
a load of the memory is distributed among a plurality of local or remote memory storage devices based on an amount of memory usage.
